(19) United States
(12) Patent Application Publication
(10) Pub. No.: US 2022/0022229 A1
(43) Pub. Date: Jan. 20, 2022

(54) TELECOMMUNICATIONS APPARATUS AND METHODS

(71) Applicant: Sony Group Corporation, Tokyo (JP)

(72) Inventors: Shin Horng WONG, Basingstoke (GB); Martin Warwick BEALE, Basingstoke (GB); Basuki PRIYANTO, Lund (SE)

(73) Assignee: Sony Group Corporation, Tokyo (JP)

(21) Appl. No.: 17/428,638

(22) PCT Filed: Jan. 9, 2020
(86) PCT No.: PCT/EP2020/050441

§ 371 Date: Aug. 5, 2021

(30) Foreign Application Priority Data
Feb. 14, 2019 (EP) 19157131.4

(51) Int. Cl. H04W 72/12

(52) U.S. Cl. CPC H04W 72/1278; H04W 72/1231

(57) ABSTRACT

A method of operating a terminal device in a wireless telecommunication system, the method comprising: determining a first preconfigured uplink resource configuration to use for a plurality of preconfigured uplink resource transmissions; transmitting data in accordance with the first preconfigured uplink resource configuration; determining the first preconfigured uplink resource configuration should be changed; determining a second preconfigured uplink resource configuration to use for a plurality of preconfigured uplink resource transmissions; and transmitting data in accordance with the second preconfigured uplink resource configuration.

### BACKGROUND

### Field

The present disclosure relates to wireless telecommunications apparatus and methods.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Latest generation mobile telecommunication systems, such as those based on the 3GPP defined UMTS and Long Term Evolution (LTE) architecture, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Future wireless communications networks will be expected to efficiently support communications with an ever-increasing range of devices and data traffic profiles than existing systems are optimised to support. For example it is expected future wireless communications networks will be expected to efficiently support communications with devices including reduced complexity devices, machine type communication devices, high resolution video displays, virtual reality headsets and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for future wireless communications networks, for example those which may be referred to as 5G or new radio (NR) system/new radio access technology (RAT) systems, as well as future iterations/releases of existing systems, to efficiently support connectivity for a wide range of devices associated with different applications and different characteristic data traffic profiles and requirements.

One example area of current interest in this regard includes the so-called “Internet of Things”, or IoT for short. The 3GPP has proposed in Release 13 of the 3GPP specifications to develop technologies for supporting narrowband (NB)-IoT and so-called enhanced MTC (eMTC) operation using a LTE/4G wireless access interface and wireless infrastructure. More recently there have been proposals to build on these ideas in Release 14 of the 3GPP specifications with so-called enhanced NB-IoT (eNB-IoT) and further enhanced MTC (feMTC), and in Release 15 of the 3GPP specifications with so-called further enhanced NB-IoT (feNB-IoT) and even further enhanced MTC (efeMTC). See, for example, [1], [2], [3], [4]. The IoT is further enhanced in 3GPP by the introduction of two additional Release 16 Work Items, namely A-MTC (Additional Machine Type Communications Enhancements) [5] and A-NB-IoT (Additional Enhancement for Narrowband Internet of Things) [6].

One approach currently considered to be of interest in the context of these technologies is the support of uplink transmissions on preconfigured uplink resources (PUR). That is to say, the support of data transmission by a terminal device using radio resources which are not specifically allocated to the terminal device on request for a particular transmission, but which the terminal device is preconfigured to use. It is expected this approach will help reduce the amount of signalling overhead associated with certain uplink transmissions, and consequently also help reduce power consumption by terminal devices making transmissions use of PUR. For further details on proposals for using preconfigured uplink resources see, for example, the 3GPP document “Final Report of 3GPP TSG RAN WG1 #94bis v1.0.0 (Chengdu, China, 8-12 Oct. 2018)”, R1-1812101, 3GPP TSG RAN WG1 Meeting #95, Spokane, USA, 12-16 Nov. 2018 [7]

The inventors have recognized the desire to support transmissions on preconfigured uplink resources gives rise to new challenges that need to be addressed to help optimise the operation of wireless telecommunications systems.

### SUMMARY

The present disclosure can help address or mitigate at least some of the issues discussed above.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of a LTE-type wireless telecommunication network which may be configured to operate in accordance with certain embodiments of the present disclosure;

FIG. 2 schematically represents some aspects of a new radio access technology (RAT) wireless telecommunications network which may be configured to operate in accordance with certain embodiments of the present disclosure;

FIG. 3 schematically represents some aspects of a wireless telecommunication network in accordance with certain embodiments of the disclosure;

FIG. 4 is a signalling ladder diagram schematically representing some aspects of signalling between a terminal device and a radio network access node in a wireless telecommunication network in accordance with certain embodiments of the disclosure;

FIG. 5 is a signalling ladder diagram schematically representing some aspects of signalling between a terminal device and a radio network access node in a wireless telecommunication network in accordance with certain embodiments of the disclosure;

FIG. 6 is a flow diagram schematically representing some operating aspects of a terminal device in accordance with certain embodiments of the disclosure; and

FIG. 7 is a flow diagram schematically representing some operating aspects of a network access node in accordance with certain embodiments of the disclosure.

### DETAILED DESCRIPTION OF THE EMBODIMENTS

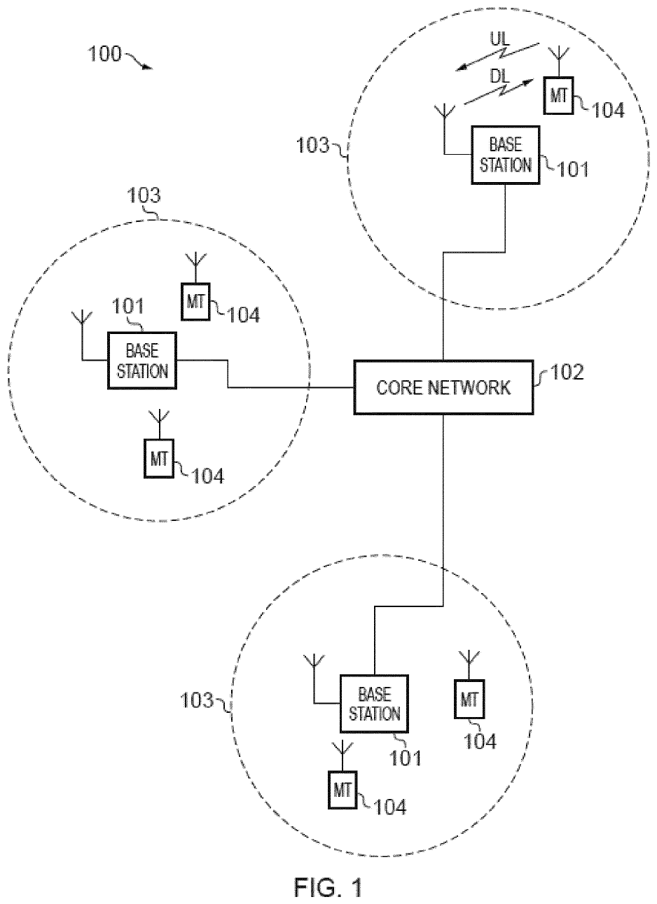

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP® body and associated proposals, and also described in many books on the subject, for example, Holma H. and Toskala A [8]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network 102. Each base station provides a coverage area 103 within which data can be communicated to and from terminal devices 104. Data is transmitted from base stations 101 to terminal devices 104 within their respective coverage areas 103 via a radio downlink. The coverage area may be referred to as a cell. Data is transmitted from terminal devices 104 to the base stations 101 via a radio uplink. The core network 102 routes data to and from the terminal devices 104 via the respective base stations 101 and provides functions such as authentication, mobility management, charging and so on. Terminal devices may also be referred to as mobile stations, user equipment (UE), user terminal, mobile radio, communications device, and so forth. Base stations, which are an example of network infrastructure equipment/network access node, may also be referred to as transceiver stations/nodeBs/e-nodeBs, g-nodeBs and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

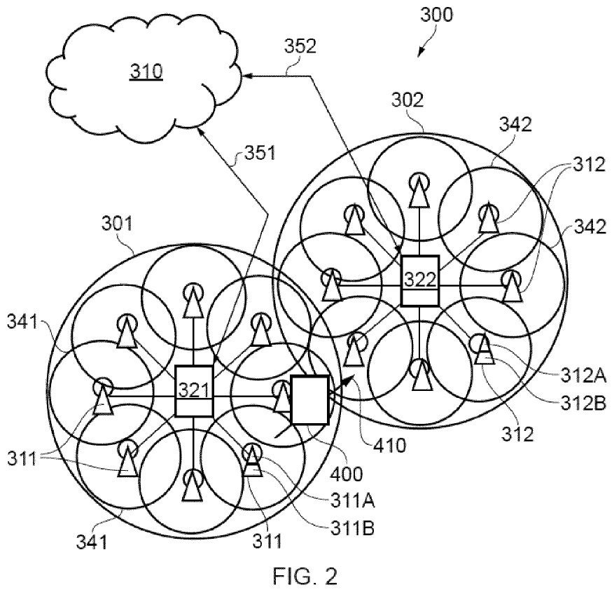

FIG. 2 is a schematic diagram illustrating a network architecture for another RAT wireless mobile telecommunications network/system 300 based on previously proposed approaches which may also be adapted to provide functionality in accordance with embodiments of the disclosure described herein. The new RAT network 300 represented in FIG. 2 comprises a first communication cell 301 and a second communication cell 302. Each communication cell 301, 302, comprises a controlling node (centralised unit) 321, 322 in communication with a core network component 310 over a respective wired or wireless link 351, 352. The respective controlling nodes 321, 322 are also each in communication with a plurality of distributed units (radio access nodes/remote transmission and reception points (TRPs)) 311, 312 in their respective cells. Again, these communications may be over respective wired or wireless links. The distributed units 311, 312 are responsible for providing the radio access interface for terminal devices connected to the network. Each distributed unit 311, 312 has a coverage area (radio access footprint) 341, 342 which together define the coverage of the respective communication cells 301, 302. Each distributed unit 311, 312 includes transceiver circuitry 311a, 312a for transmission and reception of wireless signals and processor circuitry 311b, 312b configured to control the respective distributed units 311, 312.

In terms of broad top-level functionality, the core network component 310 of the telecommunications system represented in FIG. 2 may be broadly considered to correspond with the core network 102 represented in FIG. 1, and the respective controlling nodes 321, 322 and their associated distributed units/TRPs 311, 312 may be broadly considered to provide functionality corresponding to base stations of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the terminal devices may lie with the controlling node/centralised unit and/or the distributed units/TRPs.

A terminal device 400 is represented in FIG. 2 within the coverage area of the first communication cell 301. This terminal device 400 may thus exchange signalling with the first controlling node 321 in the first communication cell via one of the distributed units 311 associated with the first communication cell 301. In some cases communications for a given terminal device are routed through only one of the distributed units, but it will be appreciated in some other implementations communications associated with a given terminal device may be routed through more than one distributed unit, for example in a soft handover scenario and other scenarios. The particular distributed unit(s) through which a terminal device is currently connected through to the associated controlling node may be referred to as active distributed units for the terminal device. Thus the active subset of distributed units for a terminal device may comprise one or more than one distributed unit (TRP). The controlling node 321 is responsible for determining which of the distributed units 311 spanning the first communication cell 301 is responsible for radio communications with the terminal device 400 at any given time (i.e. which of the distributed units are currently active distributed units for the terminal device). Typically this will be based on measurements of radio channel conditions between the terminal device 400 and respective ones of the distributed units 311. In this regard, it will be appreciated the subset of the distributed units in a cell which are currently active for a terminal device will depend, at least in part, on the location of the terminal device within the cell (since this contributes significantly to the radio channel conditions that exist between the terminal device and respective ones of the distributed units).

In at least some implementations the involvement of the distributed units in routing communications from the terminal device to a controlling node (controlling unit) is transparent to the terminal device 400. That is to say, in some cases the terminal device may not be aware of which distributed unit is responsible for routing communications between the terminal device 400 and the controlling node 321 of the communication cell 301 in which the terminal device is currently operating. In such cases, as far as the terminal device is concerned, it simply transmits uplink data to the controlling node 321 and receives downlink data from the controlling node 321 and the terminal device has no awareness of the involvement of the distributed units 311. However, in other embodiments, a terminal device may be aware of which distributed unit(s) are involved in its communications. Switching and scheduling of the one or more distributed units may be done at the network controlling node based on measurements by the distributed units of the terminal device uplink signal or measurements taken by the terminal device and reported to the controlling node via one or more distributed units

In the example of FIG. 2, two communication cells 301, 302 and one terminal device 400 are shown for simplicity, but it will of course be appreciated that in practice the system may comprise a larger number of communication cells (each supported by a respective controlling node and plurality of distributed units) serving a larger number of terminal devices.

It will further be appreciated that FIG. 2 represents merely one example of a proposed architecture for a new RAT telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2, and indeed in networks supporting aspects of different architectures in parallel, for example with co-existence of a legacy radio access network architecture, e.g., as schematically represented in FIG. 1, with a new RAT architecture, e.g., as schematically represented in FIG. 2. It will be appreciated the specific wireless telecommunications architecture in any given implementation is not of primary significance to the principles described herein. In this regard, certain embodiments of the disclosure may be described generally in the context of communications between network infrastructure equipment/access nodes and terminal devices, wherein the specific nature of the network infrastructure equipment/access nodes and terminal devices will depend on the specific network infrastructure for the implementation at hand. For example, in some scenarios the network infrastructure equipment/access nodes may comprise base stations, such as LTE-type base stations 101 as shown in FIG. 1, which are adapted to provide functionality in accordance with the principles described herein, and in other examples the network infrastructure equipment may comprise control units/controlling nodes 321, 322 and/or TRPs 311, 312 of the kind shown in FIG. 2 which are adapted to provide functionality in accordance with the principles described herein, and in yet other scenarios the network infrastructure equipment/access nodes may comprise both base stations, such as LTE-type base stations 101 as shown in FIG. 1 and control units/controlling nodes 321, 322 and/or TRPs 311, 312 of the kind shown in FIG. 2 with at least one being adapted to provide functionality in accordance with the principles described herein.

Mobile communications networks such as the network 100 shown in FIG. 1 and the network 300 shown in FIG. 2 may support preconfigured uplink grant transmissions. A preconfigured uplink grant transmission comprises a transmission of data in accordance with a predefined configuration, for example in terms of pre-determined radio resources on a physical uplink shared channel (PUSCH) of a radio sub-frame structure used by a receiving entity such as an LTE-type base station 101 as shown in FIG. 1 and control units/controlling nodes 321, 322 and/or TRPs 311, 312 of the kind shown in FIG. 2. Thus a characteristic of certain PUR schemes is that a terminal device may be operable to transmit data in accordance with a predefined configuration (e.g. a dedicated PUR configuration for the terminal device). Because the PUR configuration is predefined, the terminal device may transmit data that has become available for uplink transmission in accordance with its PUR configuration (for example using time and frequency radio resources defined by the PUR configuration), without first needing to request a specific allocation of radio resources to transmit the data or to establish a radio resource control (RRC) connection, for example by performing a RACH (random access channel) procedure, if the terminal device is in an idle mode when data becomes available for transmission. The specific PUR configuration may be dedicated to a particular terminal device so the network is aware of which terminal device has transmitted the data based on the PUR configuration used (for example the radio resources used).

A PUR configuration may include settings for parameters such as:
Timing Advance (TA) invalidation timer (i.e. an indication of the time after which the terminal device should determine a new timing advance)
Terminal device transmission power (i.e. an indication of the power the terminal device should use for its PUR transmissions)
Repetition (i.e. an indication of the degree of repetition (redundancy) the terminal device should use for its PUR transmissions)
MCS (i.e. an indication of a modulation coding scheme the terminal device should use for its PUR transmissions)
Time and frequency resources (i.e. an indication of times and/or frequencies for radio resources the terminal device should use for its PUR transmissions)
Time offset (i.e. an indication of the time offset of PUR transmission opportunities for the terminal device relative to a predefined reference time point, for example the first sub-frame in a frame)
Number of PUR allocations (i.e. an indication of how many PUR transmission opportunities are available for the terminal device to use for PUR transmissions according to the current PUR configuration before the PUR allocation lapses/is removed)

It has been previously expected PUR transmissions would find applications where an appropriate PUR configuration was stable. For example, a smart meter configured to transmit reports using a wireless telecommunications system could be configured to make PUR transmissions in a way that is appropriate for its installation (for example taking account of how often it needs to transmit data, how much power and repetition it needs according to its installation location relative to network access nodes), and this configuration may be in effect permanent. However, the inventors have realised there may be scenarios in which PUR transmissions can be beneficial, but in which the most appropriate PUR configuration can be subject to change. For example, appropriate values for parameters such as the repetition and MCS may change while a terminal device is in idle mode because of changes in radio conditions or due to mobility. This can mean a PUR configuration for the terminal device can be inappropriate. In some cases, for example where radio channel conditions have improved/the terminal device has moved towards the relevant network access node, the PUR configuration may be inappropriate because it means the terminal device is wasting resources by transmitting PUR transmission with more power or repetitions than is needed for the data to be successfully received. In other cases, for example where radio channel conditions have deteriorated/the terminal device has moved away from the relevant network access node, the PUR configuration may be inappropriate because it means the terminal device is not making PUR transmissions with enough power or repetitions for the data to be successfully received.

Thus in accordance with certain embodiments of the disclosure, approaches are provided to allow for a PUR configuration for a terminal device to be changed.

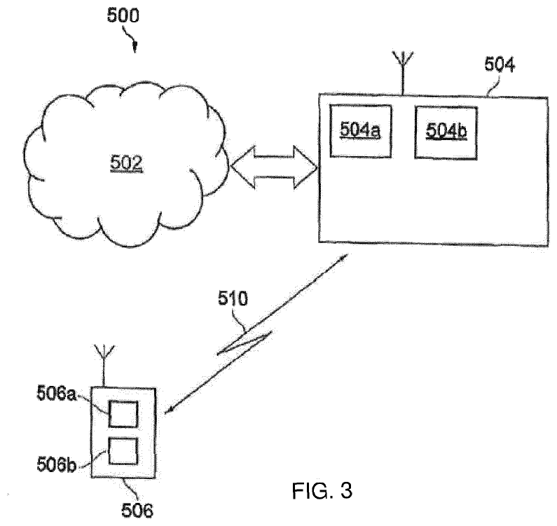

FIG. 3 schematically shows some further details of a telecommunications system 500 supporting communications between a radio access node 504 and a terminal device 506 according to certain embodiments of the present disclosure. For the sake of an example, the telecommunications system 500 here is assumed to be based broadly around an LTE-type architecture that may also support other radio access technologies, either using the same hardware as represented in FIG. 3 with appropriately configured functionality, or separate hardware configured to operate in association with the hardware represented in FIG. 3. However, the specific network architecture in which embodiments of the disclosure may be implemented is not of primary significance to the principles described herein. Many aspects of the operation of the telecommunications system/network 500 are known and understood and are not described here in detail in the interest of brevity. Operational aspects of the telecommunications system 500 which are not specifically described herein may be implemented in accordance with any known techniques, for example according to the current wireless telecommunications systems standards and other proposals for operating wireless telecommunications systems. The network access node 504 may, for convenience, sometimes be referred to herein as a base station 504, it being understood this term is used for simplicity and is not intended to imply any network access node should conform to any specific network architecture, but on the contrary, may correspond with any network infrastructure equipment/network access node that may be configured to provide functionality as described herein. In that sense it will appreciated the specific network architecture in which embodiments of the disclosure may be implemented is not of primary significance to the principles described herein.

The telecommunications system 500 comprises a core network part 502 coupled to a radio network part. The radio network part comprises the radio network access node 504 and the terminal device 506. It will of course be appreciated that in practice the radio network part may comprise more network access nodes serving multiple terminal devices across various communication cells (e.g. as schematically represented in FIG. 1). However, only one network access node and one terminal device are shown in FIG. 3 in the interests of simplicity.

The terminal device 506 is arranged to communicate data to and from the network access node (base station/transceiver station) 504 or another network access node in the wireless telecommunications system according to coverage. The network access node 504 is communicatively connected to the core network part 502 which is arranged to perform routing and management of mobile communications services for terminal devices in the telecommunications system 500 via the network access node 504. The connection from the network access nodes 504 to the core network 502 may be wired or wireless. In order to maintain mobility management and connectivity, the core network part 502 also includes a mobility management entity, MME, which manages the service connections with terminal devices operating in the communications system, such as the terminal device 506. As noted above, the operation of the various elements of the communications system 500 shown in FIG. 3 may be in accordance with known techniques apart from where modified to provide functionality in accordance with embodiments of the present disclosure as discussed herein.

The terminal device 506 is adapted to support operations in accordance with embodiments of the present disclosure as discussed herein. The terminal device 506 is a PUR capable terminal device adapted for transmitting at least some uplink data in accordance with a PUR configuration on preconfigured uplink resources to the network access node (base station) 504 over a radio interface 510. Certain embodiments of the disclosure relate to approaches for changing a current PUR configuration for the terminal device 506 to use for PUR transmissions. In this regard it will be appreciated the PUR transmissions themselves may in some examples be made in accordance with any previously proposed approaches for making PUR transmissions.

The terminal device 506 comprises transceiver circuitry 506a (which may also be referred to as a transceiver/transceiver unit) for transmission and reception of wireless signals and processor circuitry 506b (which may also be referred to as a processor/processor unit) configured to control the terminal device 506. The processor circuitry 506b may comprise various sub-units/sub-circuits for providing desired functionality as explained further herein. These sub-units may be implemented as discrete hardware elements or as appropriately configured functions of the processor circuitry. Thus the processor circuitry 506b may comprise circuitry which is suitably configured/programmed to provide the desired functionality described herein using conventional programming/configuration techniques for equipment in wireless telecommunications systems. The transceiver circuitry 506a and the processor circuitry 506b are schematically shown in FIG. 3 as separate elements for ease of representation. However, it will be appreciated that the functionality of these circuitry elements can be provided in various different ways, for example using one or more suitably programmed programmable computer(s), or one or more suitably configured application-specific integrated circuit(s)/circuitry/chip(s)/chipset(s). It will be appreciated the terminal device 506 will in general comprise various other elements associated with its operating functionality, for example a power source, user interface, and so forth, but these are not shown in FIG. 3 in the interests of simplicity.

The network access node 504 comprises transceiver circuitry 504a (which may also be referred to as a transceiver/transceiver unit) for transmission and reception of wireless signals and processor circuitry 504b (which may also be referred to as a processor/processor unit) configured to control the respective network access node 504 to operate in accordance with embodiments of the present disclosure as described herein. Thus, the processor circuitry 504b for the network access node 504 may comprise circuitry which is suitably configured/programmed to provide the desired functionality described herein using conventional programming/configuration techniques for equipment in wireless telecommunications systems. The transceiver circuitry 504a and the processor circuitry 504b are schematically shown in FIG. 3 as separate elements for ease of representation. However, it will be appreciated that the functionality of these circuitry elements can be provided in various different ways, for example using one or more suitably programmed programmable computer(s), or one or more suitably configured application-specific integrated circuit(s)/circuitry/chip(s)/chipset(s). It will be appreciated the network access node 504 will in general comprise various other elements associated with its operating functionality, such as a scheduler.

Thus, the network access node 504 is configured to communicate data with a terminal device 506 according to an embodiment of the disclosure over communication link 510.

As noted above, the inventors have recognized a need to support approaches for changing a preconfigured uplink resource configuration for a terminal device in a wireless telecommunication system. This may be, for example, to change from a first preconfigured uplink resource configuration to a second preconfigured uplink resource configuration if it is determined the first preconfigured uplink resource configuration has become less appropriate for the terminal device, for example as a result of changing radio channel conditions/terminal device mobility, or an application layer change for the type and or amount of data that the terminal device is to transmit using preconfigured uplink resource transmissions (i.e. transmissions from the terminal device to a network access node made in accordance with a preconfigured uplink resource configuration).

In some examples the terminal device may be responsible for autonomously determining a need to change the preconfigured uplink resource configuration. In these cases the terminal device may transmit a request to the network access node to request a new preconfigured uplink resource configuration. In scenarios where the need to change the preconfigured uplink resource configuration is because the terminal device is no longer able to reliably transmit data using the current preconfigured uplink resource configuration (for example because of a deterioration in radio channel conditions), the terminal device may transmit the request for a new preconfigured uplink resource configuration in association with a random access procedure. In scenarios where the need to change the preconfigured uplink resource configuration is not because the terminal device is no longer able to reliably transmit data using the current preconfigured uplink resource configuration (for example when there has been an improvement in radio channel conditions meaning the terminal device can still reliably transmit data using less power or fewer repetitions), the terminal device may transmit the request for a new preconfigured uplink resource configuration in a preconfigured uplink resource configuration transmission. In some examples the request for a new preconfigured uplink resource configuration may comprise reference signalling transmitted by the terminal device, for example on resources associated with its current preconfigured uplink resource configuration. In some examples the request for a new preconfigured uplink resources configuration may be made using radio resource control signalling.

When the network access node receives a request from the terminal device for a new preconfigured uplink resource configuration, it may establish a suitable new preconfigured uplink resource configuration and transmit an indication of this to the terminal device. The transmission of the indication of the new preconfigured uplink resource configuration from the network access node to the terminal device may be made in downlink signalling associated with a random access procedure initiated by the terminal device to request the new preconfigured uplink resource configuration, or may be made in association with downlink control information signalling, for example, in association with acknowledgement signalling transmitted by the network access node in response to the request from the terminal device for the new preconfigured uplink resource configuration. In some examples the transmission of the indication of the new preconfigured uplink resource configuration may be made using radio resource control signalling. In some cases the indication of the new preconfigured uplink resource configuration may comprise an indication of new values/settings for at least one parameter comprising the preconfigured uplink resource configuration. In some other cases there may be a plurality of predefined preconfigured uplink resource configurations stored at the terminal device, and the indication of the new preconfigured uplink resource configuration from the network access node may be an indication of one of the predefined preconfigured uplink resource configurations, for example a corresponding predefined index number. In this regard the predefined preconfigured uplink resource configurations may, for example, be defined by standard or in prior radio resource control signalling.

In some examples the network access node may be responsible for autonomously determining a need to change the preconfigured uplink resource configuration. In these cases the network access node may transmit an indication of the new preconfigured uplink resource configuration to the terminal device, for example, in association with downlink control information signalling or radio resource control signalling, or indeed in accordance with any appropriate technique for reconfiguring operating aspects of a terminal device. The terminal device may thus determine its current preconfigured uplink resource configuration should be changed from having received the indication of the new preconfigured uplink resource configuration being received from the radio network access node. That is to say, the terminal device may determine the preconfigured uplink resource configuration should be changed by virtue of being told by the base station.

The different preconfigured uplink resource configurations for the terminal device may comprise different values/settings for various parameters, and any or all of these may be changed to provide a new preconfigured uplink resource configuration. For example, a preconfigured uplink resource configuration may comprise settings for one or more parameters selected from the group comprising: (i) an indication of a time after which the terminal device should determine a new timing advance; (ii) an indication of a power the terminal device should use for transmitting data in accordance with the first preconfigured uplink resource configuration; (iii) an indication of the degree of repetition the terminal device should use for transmitting data in accordance with the first preconfigured uplink resource configuration; (iv) an indication of a modulation coding scheme the terminal device should use for transmitting data in accordance with the first preconfigured uplink resource configuration; (v) an indication of times and/or frequencies for radio resources the terminal device should use for transmitting data in accordance with the first preconfigured uplink resource configuration; (vi) an indication of periodicity for the opportunities for transmitting data in accordance with the first preconfigured uplink resource configuration (i.e. a time between different opportunities for transmitting data in accordance with the first preconfigured uplink resource configuration) and/or a start time for the opportunities for transmitting data in accordance with the first preconfigured uplink resource configuration relative to a predefined reference time point; and (vii) an indication of a number of transmission opportunities available for the terminal device to use for transmissions in accordance with the first preconfigured uplink resource configuration.

Thus, a terminal device, such as the terminal device 506 schematically represented in FIG. 3, may be configured for preconfigured uplink resource transmissions on a physical uplink shared channel, PUSCH, to a radio network access node, such as the network access node 504 schematically represented in FIG. 3. In this regard the implementation of the preconfigured uplink resource transmissions themselves may be in accordance with previously proposed approaches. However, in accordance with certain embodiments of the disclosure, the terminal device may be configured to signal to the network access node a request for a change to its preconfigured uplink resources configuration (PUR configuration parameters). For example, the terminal device may signal this request for a change in PUR configuration parameters after detecting that its radio conditions have changed.

For example, the terminal device 506 may be configured to determine its current (first) preconfigured uplink resource configuration should be changed to a new (second) preconfigured uplink resource configuration based on measurements of radio channel conditions. For example, the terminal device 506 may be configured to measure radio channel conditions for the radio path between the terminal device 506 and the network access node 504, for example based on measurements of a signal strength for signalling received by the terminal device from the network access node, such as a reference signal received power, RSRP. If the measurements indicate the radio channel conditions have deteriorated to the extent PUR transmissions made in accordance with the current PUR configuration may not meet a reliability target, for example because the current PUR configuration specifies too little power and/or too few repetitions and/or an inappropriate modulation coding scheme for the degraded radio channel conditions, the terminal device may request a change to its current PUR configuration, for example to switch to a more robust configuration providing greater redundancy. Conversely, if the measurements indicate the radio channel conditions have improved to the extent PUR transmissions made in accordance with the current PUR configuration is wasting resources, for example because the current PUR configuration specifies more transmission power and/or more repetitions and/or a modulation coding scheme that is unnecessarily conservative for meeting a reliability target for the improved radio channel conditions, the terminal device may request a change to its current PUR configuration, for example to switch to a less robust configuration providing less redundancy.

In some example implementations, the terminal device 506 may be configured to receive acknowledgement signalling (e.g. hybrid automatic repeat request, HARQ, signalling) in response to PUSCH transmissions made in accordance with its preconfigured uplink resources configuration. In these cases the terminal device may be configured to determine its current (first) preconfigured uplink resource configuration should be changed to a new (second) preconfigured uplink resource configuration if the terminal device fails to receive acknowledgement signalling for a predetermined number of PUSCH transmissions made in accordance with its current preconfigured uplink resource configuration.

In some examples a preconfigured uplink resource configuration may comprise multiple potential settings for a given parameter, for example a modulation coding scheme, and the terminal device may be able to make transmissions in accordance with the preconfigured uplink resource configuration using use different settings for these parameters to seek to optimise its current transmissions before determining that it should change to a new preconfigured uplink resource configuration. For example, a particular preconfigured uplink resource configuration may comprise multiple settings for repetition and modulation coding scheme, and the terminal device can select different settings for PUR transmissions, and not to determine a new preconfigured uplink resource configuration is needed until none of the settings are considered appropriate.

In implementations in which the terminal device autonomously determines the current preconfigured uplink resource configuration should be changed to a new preconfigured uplink resource configuration, there are various approaches that may be used by the terminal device to inform the network access node.

In some example implementations, a request for a change in PUR configuration/parameters may be signalled from the terminal device to the network access node in association with uplink signalling of a random access procedure initiated by the terminal device in response to determining the current preconfigured uplink resource configuration should be changed. For example, the request for a new preconfigured uplink resource configuration may be transmitted in a third message of a random access procedure using Early Uplink Data Transmission over Message 3 (EDT) techniques.

EDT is a feature introduced in Release 15 of the 3GPP standards which allows a terminal device to transmit and/or receive data during a random access procedure whilst in idle mode.

In accordance with certain embodiments of the disclosure, data transmitted by the terminal device during a random access procedure may comprise an indication of a request for a change in preconfigured uplink resource configuration and data received by the terminal device from the network access node may comprise an indication of a new preconfigured uplink resource configuration.

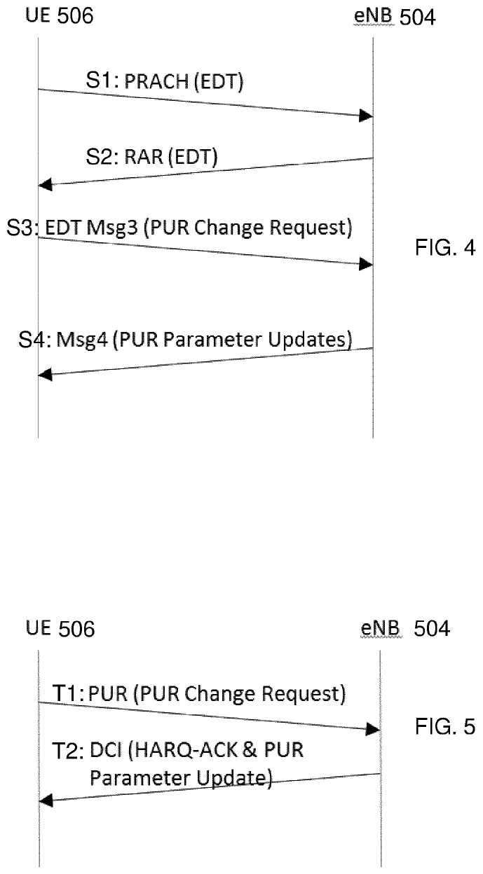

FIG. 4 is a ladder diagram that schematically shows message exchange between the terminal device 506 (UE) and the network access node 504 (eNB) for a random access procedure in accordance with an embodiment of the disclosure. As already mentioned, it will be appreciated aspects of this operation which are not specifically described herein, for example the particular signalling protocols adopted, may be implemented in accordance with conventional techniques for communicating in wireless telecommunications systems. The processing represented in FIG. 4 takes place after the terminal device has autonomously determined that its current preconfigured uplink resource configuration should be changed, for example using any of the techniques discussed herein.

The terminal device starts the process in step S1 by transmitting a random access request on a physical random access channel (PRACH in an LTE context), i.e. a random access preamble (RACH preamble), to the network access node. In accordance with previously proposed techniques for EDT transmissions, the random access preamble (signature sequence) may be selected from a group of random access preambles which are dedicated for use by terminal devices wishing to indicate a desire to transmit EDT data in association with the random access procedure initiated by the transmission of the random access preamble.

In step S2, when the network access node detects the preamble it will respond with a Random Access Response message (RAR), which is also known as Message 2. In accordance with previously proposed techniques for EDT transmissions, the RAR may comprise an indication the network access node is allowing the terminal device to transmit EDT data in association with message three of the random access procedure. The RAR is scheduled by downlink control information (DCI) carried on a physical downlink control channel, e.g. MPDCCH in an LTE implementation for machine type communication (MTC) traffic. The RAR itself is transmitted on a physical downlink shared channel (PDSCH) resource allocated via the DCI. The DCI is addressed to an RA-RNTI (random access radio network temporary identifier) which is derived from the time and frequency resources used to transmit the preamble in step S1, and the RAR will indicate which preamble the network access node has detected and is responding to. The RAR of step S2 also contains an uplink grant for the preamble the network is responding to so that the terminal device that transmitted the preamble may use this uplink grant to transmit an RRC message, also known as Message 3 to the network access node, and significantly, in accordance with proposed EDT techniques, the uplink grant for message 3 indicated in the RAR may allocate sufficient resources for the message 3 to include EDT data. In some examples, the RRC message carried in Message 3 may be an RRC Connection Request message, but the approach is not limited to application to this particular RRC message.

In step S3, the terminal device transmits Message 3 of the random access procedure on the resources indicated by the uplink grant received in association with the RAR in step S2. The message 3 transmission of step S3 includes the EDT data, which in this example is the request by the terminal device for an updated preconfigured uplink resource grant configuration and potentially indicating the nature of the change requested, for example by indicating a need for more repetitions (the specific formatting for request is not of primary significance to the principles described herein). In this regard, in accordance with some example approaches the terminal device may determine the nature of the requested change based on a measured change in radio channel conditions (e.g. a 3 dB fall in received power may lead to a request for a 3 dB in increase in transmit power or corresponding increase in repetitions). In other example approaches the terminal device may determine the nature of the requested change based on an indication received from an application being supported by the terminal device (e.g. the application may report a need to send more data and this may lead to a request for a corresponding increase in transport block size for the preconfigured uplink resource grant configuration).

In step S4, having received the request for a changed PUR configuration in the EDT data in Message 3 of the random access procedure in step S3, i.e. having determined the terminal device's current preconfigured uplink resource configuration should be changed, the network access node reconfigures the terminal device's PUR parameters by transmitting an indication of the new preconfigured uplink resource configuration to the terminal device in association with message 4 of the random access procedure. An advantage of the approach of the network access node transmitting the indication of the changed preconfigured uplink resources configuration in message four of the random access procedure is that it can help avoid the terminal device needing to transition to RRC connected mode to receive the indication of the changed preconfigured uplink resource configuration.

Thus, in accordance with the procedure represented in FIG. 4, a terminal device that determines its preconfigured uplink resource configuration should change, can transmit a request to the network access node for an updated preconfigured uplink resource configuration in Message 3 of a random access procedure using EDT, and may receive an indication of the updated preconfigured uplink resource configuration from the radio network access node in Message 4 of the random access procedure.

It will be appreciated the approach represented in FIG. 4 may be modified for other implementations.

For example, in some cases, rather than use EDT to include an indication of a request for an updated preconfigured uplink resource configuration in message 3, the random access preamble itself may be used to indicate a request for an updated preconfigured uplink resource configuration. For example, there may be a group of random access preambles which are predefined in the wireless telecommunication system for a terminal device to indicate it is requesting an updated preconfigured uplink resource configuration. Thus, if the terminal device determines its current preconfigured uplink resource configuration should be changed, it may initiate a random access procedure using a random access preamble (signature sequence) which is selected from among the predefined group of random access preambles associated with an indication of a request for an updated preconfigured uplink resource configuration.

In some cases, rather than receive the indication of the change in preconfigured uplink resource configuration from the network access node in message 4 of the random access procedure, the terminal device may instead complete the random access procedure to transition to RRC connected mode and receive the indication of the change in preconfigured uplink resource configuration in RRC connected mode signalling.

An approach for transmitting a request for an updated preconfigured uplink resource configuration in association with a random access procedure, such as schematically represented in FIG. 4, may be particularly suitable in situations where the desire for an updated preconfigured uplink resource configuration arises because the current preconfigured uplink resource configuration is no longer suitable due to a deterioration in radio channel conditions. This is because the deterioration in radio channel conditions may mean the terminal device is not able to reliably communicate a request for an updated preconfigured uplink resource configuration using a PUR transmission in accordance with its current preconfigured uplink resource configuration. However, by using a random access procedure to transmit the request for the updated preconfigured uplink resource configuration, the deterioration in radio channel conditions can be accounted for using conventional random access procedures, for example using a ramping procedure for transmitting the random access preamble (i.e. where the terminal device increases the power and/or repetition level for the random access preamble until it receives a RAR from the network access node in response).

The approach represented in FIG. 4 of using a random access procedure with EDT may in effect be considered a unique/special application of EDT techniques in which the purpose is to convey PUR change requests/PUR configuration updates. EDT is itself associated with various configuration settings for the terminal device, such as modulation coding scheme (MCS), transport block size (TBS), physical resource block (PRB) size, some of which can be selected by the terminal device, for example having regard to the amount of uplink data that the terminal device wished to transmit using EDT. However, in some examples of approaches according to the present disclosure, the signalling format for the request for an updated preconfigured uplink resource configuration, for example the configuration settings for the EDT transmission in step S3 in FIG. 4, may be predefined to help reduce the complexity of EDT operation for the purpose of conveying PUR change requests. For example, a preamble resource reserved for requesting PUR configuration changes via EDT may be used in step S1. When the network access node receives such a preamble sequence, it can prepare to receive EDT in message 3 with a known format. Alternatively, the network access node can schedule a specific transport block size for the terminal device to use in a non-EDT transmission in message 3 in step S3.

Whereas FIG. 4 represents an approach for the terminal device to transmit an indication of a request for a changed preconfigured uplink resource configuration using a random access procedure, in other examples the terminal device may transmit an indication of a request for a changed preconfigured uplink resource configuration using radio resources associated with the current preconfigured uplink resource configuration.

FIG. 5 is a ladder diagram that schematically shows message exchange between the terminal device 506 (UE) and the network access node 504 (eNB) in accordance with an embodiment of the disclosure. As already mentioned, it will be appreciated aspects of this operation which are not specifically described herein, for example the particular signalling protocols adopted, may be implemented in accordance with conventional techniques for communicating in wireless telecommunications systems. The processing represented in FIG. 5 takes place after the terminal device has autonomously determined that its current preconfigured uplink resource configuration should be changed, for example using any of the techniques discussed herein. In this example it is assumed the terminal device has determined its current preconfigured uplink resource configuration should be changed because of an improvement in radio channel conditions.

In accordance with this approach the terminal device is still able to communicate with the network access node with transmissions made in accordance with the preconfigured uplink resource configuration. Thus, in step T1 the terminal device transmits a request to change its preconfigured uplink resource configuration in a preconfigured uplink resource configuration transmission according to its current preconfigured uplink resource configuration. The signalling in step T1 may include an indication of the nature of the change requested, for example by indicating a need for fewer repetitions (the specific formatting for request is not of primary significance to the principles described herein).

In step T2, having received the request for a changed PUR configuration in the PUR transmission in step T1, i.e. having determined the terminal device's current preconfigured uplink resource configuration should be changed, the network access node reconfigures the terminal device's PUR parameters by transmitting an indication of the new preconfigured uplink resource configuration to the terminal device. In this example implementation, the indication of the change in preconfigured uplink resource configuration is transmitted to the terminal device in association with downlink control information (DCI) signalling associated with HARQ acknowledgement signalling for the PUR transmission of step T1. It may be noted this DCI signalling may also be used to facilitate other aspects of PUR operation, for example by resetting a terminal device's timing advance.

It will be appreciated the approach of FIG. 5 can be modified for other implementations. For example, although the approach of FIG. 5 shows the terminal device transmitting a request for an updated preconfigured uplink resource configuration after the terminal device has autonomously determined its preconfigured uplink resource configuration should be changed, for example because of an observed change in radio channel conditions, in other examples the radio network access node itself can autonomously determine the preconfigured uplink resource configuration for the terminal device should be changed. This is because the radio network access node itself can determine the nature of the radio channel conditions between the terminal device and the network access node based on measurements of the signalling received from the terminal device. For example, if the network access node is unable to correctly decode a PUR transmission from the terminal device, the network access node may determine there has been a deterioration in radio channel conditions and transmit to the terminal device an indication of a change in preconfigured uplink resource configuration for the terminal device to apply, for example in association with DCI for HARQ acknowledgement signalling as indicated in step T2 in FIG. 5. Conversely, if the network access node determines there is an improvement in radio channel conditions, for example because the network access node is able to successfully decode a PUR transmission from the terminal device before receiving all of the scheduled repetitions, it may transmit to the terminal device an indication of an appropriate change in preconfigured uplink resource configuration for the terminal device to apply (e.g. using fewer repetitions). Again this may, for example, be transmitted in association with DCI for HARQ acknowledgement signalling in the manner indicated in step T2 in FIG. 5. In this regard, in accordance with these approaches the terminal device determines its current preconfigured uplink resource configuration should be changed by virtue of receiving an indication of the changed preconfigured uplink resource configuration from the network access node.

It will be appreciated there are various other ways in which a terminal device may transmit an indication of a request for an updated preconfigured uplink resource configuration to the network access node. For example, rather than transmit the request in association with a random access procedure (such as schematically represented in FIG. 4) or as data transmitted in a PUR transmission, the terminal device may instead be configured to initiate transmission of dedicated signalling to indicate a request for an updated preconfigured uplink resource configuration. For example, in one implementation the dedicated signalling may comprise a sounding reference signal, SRS, transmitted by the terminal device on time and frequency resources associated with its current preconfigured uplink resource configuration. That is to say, in some cases a terminal device's PUR change request may be indicated by an SRS transmitted over PUR whereby this reference signalling in the uplink implicitly indicates a change in preconfigured uplink resource configuration is requested, for example because of a measured change in radio conditions. It will be appreciated the SRS also provides a means for the network access node to evaluate the terminal device's uplink radio conditions to help the network access node decide whether and how to update the terminal device's PUR parameters. Thus, in accordance with some embodiments of the disclosure, a terminal device configured for PUR transmissions may monitor downlink signalling (e.g. cell specific reference signals) and performs measurements on the downlink signalling. If these measurements indicate that the channel conditions have deteriorated, the terminal device may transmit a predefined SRS. The network access node detects the SRS and treats this as a request for an updated preconfigured uplink resource configuration for the terminal device, and from measurements on the SRS may determine a new PUR configuration for the terminal device. It will be appreciated that configuring the terminal device to only transmit SRS signalling in case an updated preconfigured uplink resource configuration is requested can help the terminal device save transmission power resources as compared to the situation in which a terminal device transmits SRS signalling on a periodic basis.

In accordance with the examples discussed above with reference to FIGS. 4 and 5, the terminal device is provided with the updated preconfigured uplink resources configuration in response to it being determined the current preconfigured uplink resource configuration should be changed. However, in other examples the terminal device may be preconfigured with multiple preconfigured uplink resource configurations so that when it is determined the terminal device should change its current preconfigured uplink resource configuration for another preconfigured uplink resource configuration, it may do so by switching to one of the other preconfigured PUR configurations without the configuration itself being transmitted to the terminal device. That is to say a terminal device may be configured with multiple PUR configurations, but only a subset of these PUR configurations are used for PUSCH transmission. For example, the network access node can configure the terminal device to have two PUR configurations, one for Coverage Enhancement (CE) Mode A (i.e. for a terminal device in good radio conditions) and another in CE Mode B (i.e. for terminal device in poor radio conditions). The network access node can then switch the terminal device between these two configurations depending on the terminal device's current radio condition. This switch can be indicated using DCI or RRC signalling, for example (for example in Message 4 of an random access procedure) or RRC connected mode signalling. It will be appreciated this example approach can be used without the terminal device itself signalling a PUR change request to the network since the network access node itself can detect the terminal device's radio conditions from its PUSCH transmissions in the uplink.

In some examples, the terminal device can be assigned with multiple PUR configurations and more than one of those PUR configurations can be active at the same time. For example a terminal device may have two applications running, where the reporting periodicities and packet sizes of the two applications are different. In this case, it can be more efficient to assign the UE with two active PUR configurations. The UE may require the configuration of a subset of those multiple PUR configurations to be changed, hence the UE may indicate in the PUR change request the identity of the PUR configuration that it is requesting to be modified. The network access node may respond with an indication of which PUR configuration is being updated.

In some examples, one of the multiple PUR configurations may be considered a fall back PUR configuration. That is to say, the terminal device may be configured with at least two PUR configurations, i.e. a first (current) PUR configuration which is configured according to current radio conditions, and a second (fall back) PUR configuration that is configured more conservatively, e.g. with a higher number of repetitions and/or greater transmission power and/or a lower rate MCS, so that it is more robust. That is to say, the fall back preconfigured uplink resource configuration is defined so that transmissions made in accordance with the fall back preconfigured uplink resource configuration have a greater chance of being successfully received than transmissions made in accordance with the current preconfigured uplink resource configuration for the same radio channel conditions.

Thus the fall back PUR may be used when it is determined the terminal device's radio conditions deteriorate or after the terminal device fails to receive HARQ acknowledgement signalling after a predetermined number of PUR PUSCH transmissions using the current PUR configuration. The radio resources associated with the current and fall back preconfigured uplink resource configurations may comprise the same frequencies but different times. For example, the two PUR configurations may share the same frequency resources but different time resource. For example, the current PUR configuration may have a period that is shorter than the fall back PUR configuration. There may also be a time offset between the current PUR configuration and the fall back PUR configuration.

Typically a preconfigured uplink resources configuration will be dedicated to a specific UE (for example to reduce the likelihood of collisions). However, in some implementations which adopt an approach of having a predefined fall back preconfigured uplink resource configuration for a terminal device, the fall back preconfigured uplink resource configuration may be common (i.e. shared with) a number of terminal devices, for example a predefined group of terminal devices, or simply all terminal devices being served by the network access node. That is to say the fall back PUR configuration may be a shared PUR configuration whereas each terminal device's current PUR configuration may be a dedicated PUR. This approach recognises the fall back PUR may not be used very often and hence it may not be efficient to reserve dedicated fall back resources for each terminal device. In some examples, when the network determines that a terminal device has switched to using the fall back resources, the network may treat this as an indication of the terminal device's previous dedicated PUR configuration should be changed, and provide the terminal device with an indication of an updated dedicated PUR configuration accordingly (for example in accordance with the principles described herein). Depending on the application at hand, the terminal device may also be provided with an indication of an updated fall back preconfigured uplink resource configuration.

In some example implementations a terminal device may be configured to only use a fall back preconfigured uplink resource configuration for a predetermined number of PUR transmissions, and if the terminal device does not receive an updated dedicated preconfigured uplink resource configuration within that predetermined number of PUR transmissions in accordance with the fall back preconfigured uplink resource configuration it may request a new dedicated PUR configuration in another way, e.g. by using one of the other approaches described herein. This approach can help avoid repeated collisions from multiple terminal devices using the fall back PUR configuration at the same time.

Whereas the above discussion has primarily focused on scenarios in which it is determined the preconfigured uplink resource configuration for a terminal device should be changed because of a change in radio channel conditions, it will be appreciated there can be other reasons why a preconfigured uplink resource configuration could benefit from being changed. For example, a desire to change the current preconfigured uplink resource configuration may come from higher layers, for example the application layer, due to a change in service.

For example, an application may involve using preconfigured uplink resource transmissions to allow for a terminal device to report on a process parameter, for example a temperature associated with an apparatus in a “smart” factory. A current preconfigured uplink resource configuration may be such that the terminal device reports a measurement of the temperature every 10 minutes, i.e. the preconfigured uplink resource configuration defines a 10 minute periodicity. However, the terminal device may be configured to recognise when the temperature moves outside a nominal operating band and to start more frequent reporting to help more quickly identify any potential issues. Thus, an application running on the terminal device may be configured to request an updated preconfigured uplink resource configuration to define a more frequent reporting period in response to determining the monitored temperature has moved outside its nominal operating band. As well as the application layer triggering the terminal device to request an updated preconfigured uplink resource configuration with more frequent reporting, it may also trigger the terminal device to request other changes to the preconfigured uplink resource configuration. For example, the application running on the terminal device may be configured to report additional measurements when the temperature is determined to move outside a nominal operating band, and so the application may trigger the terminal device to request an updated preconfigured uplink resource configuration that allows the terminal device to transmit more data (e.g. data from additional temperature or pressure sensors). It will be appreciated this particular application is merely one example, and more generally, any application making use of PUR transmissions may be configured to trigger a terminal device running the application to request a change in a current preconfigured uplink resource configuration according to the requirements at hand.

As noted above, a preconfigured uplink resource configuration may include an indication of a number of transmission opportunities available for the terminal device to use for preconfigured uplink resource transmissions, i.e. what might be referred to as a number of PUR cycles. For example, a preconfigured uplink resource configuration may allocate a terminal device with resources to make PUR transmissions every hour for a 24 hour period. This would mean the allocation of preconfigured uplink resources for transmissions in accordance with the preconfigured uplink resource configuration would expire after 24 cycles. In accordance with certain embodiments of the disclosure, a request by the terminal device to update its current preconfigured uplink resource configuration may in effect be a request to extend the number of PUR cycles associated with the current preconfigured uplink resource configuration. For example, the terminal device may transmit a PUR change request to indicate a request to extend the number of PUR allocations for another 24 cycles. In some example implementations a request to extend the number of PUR allocations for another 24 cycles may be considered to be implicitly made if the terminal device makes a PUR transmission within a threshold number of transmission opportunities from the end of the currently configured number of cycles. This approach can help avoid tying up resources in preconfigured uplink resource configurations for terminal devices which are no longer using them without requiring terminal devices to explicitly request preconfigured uplink resources that they do still need on a regular basis.

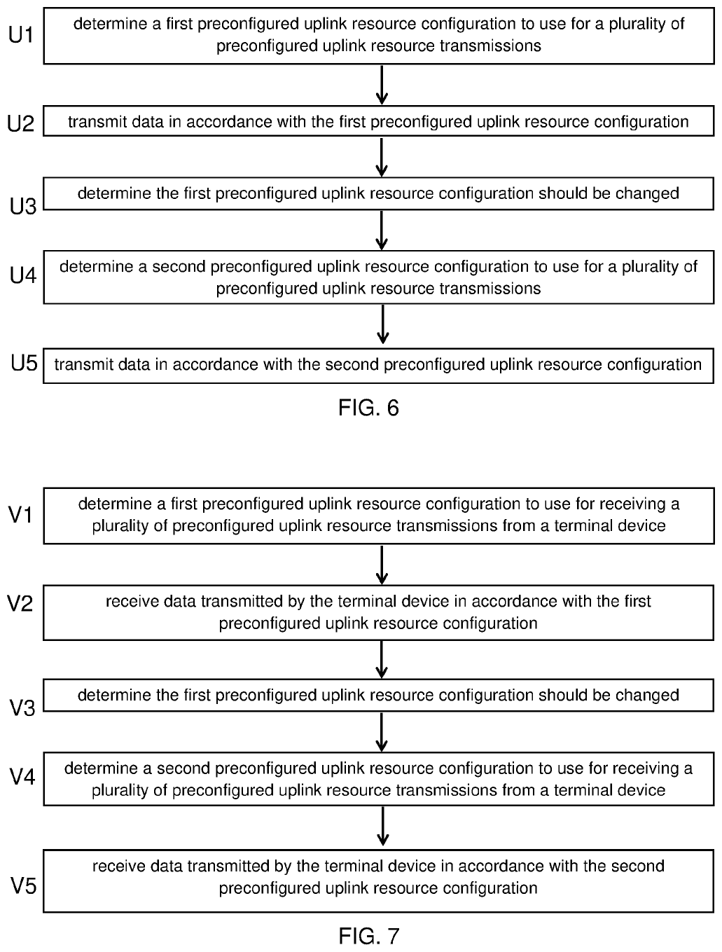

FIG. 6 is a flow diagram schematically representing some aspects of a method of operation for a terminal device in a wireless telecommunication system in accordance with certain embodiments of the disclosure.

In a first step, U1, the terminal device determines a first preconfigured uplink resource configuration to use for a plurality of preconfigured uplink resource transmissions.

In a second step, U2, the terminal device transmits data in accordance with the first preconfigured uplink resource configuration.

In a third step, U3, the terminal device determines the first preconfigured uplink resource configuration should be changed.

In a fourth step, U4, the terminal device determines a second preconfigured uplink resource configuration to use for a plurality of preconfigured uplink resource transmissions.

In a fifth step, U5, the terminal device transmits data in accordance with the second preconfigured uplink resource configuration.

FIG. 7 is a flow diagram schematically representing some aspects of a method of operation for a network access node in a wireless telecommunication system in accordance with certain embodiments of the disclosure.

In a first step, V1, the network access node determines a first preconfigured uplink resource configuration to use for receiving a plurality of preconfigured uplink resource transmissions from a terminal device.

In a second step, V2, the network access node receives data transmitted by the terminal device in accordance with the first preconfigured uplink resource configuration.

In a third step, V3, the network access determines the first preconfigured uplink resource configuration should be changed.

In a fourth step, V4, the network access node determines a second preconfigured uplink resource configuration to use for receiving a plurality of preconfigured uplink resource transmissions from a terminal device

In a fifth step, V5, the network access node receives data transmitted by the terminal device in accordance with the second preconfigured uplink resource configuration

Thus there has been described a method of operating a terminal device (and a corresponding terminal device and circuitry for a terminal device) in a wireless telecommunication system, the method comprising: determining a first preconfigured uplink resource configuration to use for a plurality of preconfigured uplink resource transmissions; transmitting data in accordance with the first preconfigured uplink resource configuration; determining the first preconfigured uplink resource configuration should be changed; determining a second preconfigured uplink resource configuration to use for a plurality of preconfigured uplink resource transmissions; and transmitting data in accordance with the second preconfigured uplink resource configuration.

There has been described a method of operating a network access node (and a corresponding network access node and circuitry for a network access node in a wireless telecommunication system), the method comprising; determining a first preconfigured uplink resource configuration to use for receiving a plurality of preconfigured uplink resource transmissions from a terminal device; receiving data transmitted by the terminal device in accordance with the first preconfigured uplink resource configuration; determining the first preconfigured uplink resource configuration should be changed; determining a second preconfigured uplink resource configuration to use for receiving a plurality of preconfigured uplink resource transmissions from a terminal device; and receiving data transmitted by the terminal device in accordance with the second preconfigured uplink resource configuration.

It will be appreciated that while the present disclosure has in some respects focused on implementations in an LTE-based and/or 5G network for the sake of providing specific examples, the same principles can be applied to other wireless telecommunications systems. Thus, even though the terminology used herein is generally the same or similar to that of the LTE and 5G standards, the teachings are not limited to the present versions of LTE and 5G and could apply equally to any appropriate arrangement not based on LTE or 5G and/or compliant with any other future version of an LTE, 5G or other standard.

It may be noted various example approaches discussed herein may rely on information which is predetermined/predefined in the sense of being known by multiple entities operating in the wireless telecommunications system, for example a radio network infrastructure equipment and a terminal device. It will be appreciated such predetermined/predefined information may in general be established, for example, by definition in an operating standard for the wireless telecommunication system, or in previously exchanged signalling between the relevant entities, for example in system information signalling, or in association with radio resource control setup signalling. That is to say, the specific manner in which the relevant predefined information is established and shared between the various elements of the wireless telecommunications system is not of primary significance to the principles of operation described herein.

It may further be noted various example approaches discussed herein rely on information which is exchanged/communicated between various elements of the wireless telecommunications system and it will be appreciated such communications may in general be made in accordance with conventional techniques, for example in terms of specific signalling protocols and the type of communication channel used, unless the context demands otherwise. That is to say, the specific manner in which the relevant information is exchanged between the various elements of the wireless telecommunications system is not of primary significance to the principles of operation described herein. Furthermore, it will be appreciated that unless the context demands otherwise, references herein to transmissions from the terminal device should be interpreted as transmissions from the terminal device to the network (i.e. to a radio network access node), and references herein to signalling received by the terminal device should be interpreted as signalling received by the terminal device from the network (i.e. from a radio network access node). Likewise, it will be appreciated that unless the context demands otherwise, references herein to transmissions from the network (i.e. from a radio network access node) should be interpreted as transmissions from the network to a terminal device, and references herein to signalling received by the network (i.e. by a radio network access node) should be interpreted as signalling received from a terminal device.

Respective features of the present disclosure are defined by the following numbered paragraphs:

Paragraph 1. A method of operating a terminal device in a wireless telecommunication system, the method comprising: determining a first preconfigured uplink resource configuration to use for a plurality of preconfigured uplink resource transmissions; transmitting data in accordance with the first preconfigured uplink resource configuration; determining the first preconfigured uplink resource configuration should be changed; determining a second preconfigured uplink resource configuration to use for a plurality of preconfigured uplink resource transmissions; and transmitting data in accordance with the second preconfigured uplink resource configuration.

Paragraph 2. The method of paragraph 1, wherein the method further comprises the terminal device making measurements of radio channel conditions and determining the first preconfigured uplink resource configuration should be changed based on the measurements of radio channel conditions.

Paragraph 3. The method of paragraph 2, wherein the measurements of radio channel comprise measurements of a signal strength for signalling received by the terminal device.

Paragraph 4. The method of any of paragraphs 1 to 3, wherein the step of determining the first preconfigured uplink resource configuration should be changed is based on the terminal device determining an application supported by the terminal device requires a change in how it reports data using the wireless telecommunication system.

Paragraph 5. The method of any of paragraphs 1 to 4, wherein the step of determining the first preconfigured uplink resource configuration should be changed is based on the terminal device determining there are less than a predetermined amount of remaining opportunities for transmitting data in accordance with the first preconfigured uplink resource configuration.

Paragraph 6. The method of any of paragraphs 1 to 5, wherein the step of determining the first preconfigured uplink resource configuration should be changed comprises the terminal device receiving signalling from another entity in the wireless telecommunication system which indicates the first preconfigured uplink resource configuration should be changed.

Paragraph 7. The method of any of paragraphs 1 to 6, wherein the method further comprises the terminal device seeking to receive acknowledgement signalling in response to previous transmissions of data made in accordance with the first preconfigured uplink resource configuration, and determining the first preconfigured uplink resource configuration should be changed in response to failing to receive acknowledgement signalling in response to a predetermined number of previous transmissions of data made in accordance with the first preconfigured uplink resource configuration.

Paragraphs 8. The method of any of paragraphs 1 to 7, wherein the method further comprises the terminal device transmitting a request to receive an indication of the second preconfigured uplink resource configuration in response to determining the first preconfigured uplink resource configuration should be changed.

Paragraph 9. The method of paragraph 8, wherein transmitting the request to receive an indication of the second preconfigured uplink resource configuration comprises initiating a random access procedure and transmitting the request to receive an indication of the second preconfigured uplink resource configuration in association with an uplink signalling message of the random access procedure.

Paragraph 10. The method of paragraph 9, wherein the uplink signalling message of the random access procedure in association with which the request to receive an indication of the second preconfigured uplink resource configuration is transmitted is a first message of the random access procedure and comprises a random access channel preamble selected from a plurality of random access channel preambles to indicate the request to receive an indication of the second preconfigured uplink resource configuration.

Paragraph 11. The method of paragraph 8, wherein the uplink signalling message of the random access procedure in association with which the request to receive an indication of the second preconfigured uplink resource configuration is transmitted is a third message of the random access procedure, wherein the third message of the random access procedure is sent in response to receiving a random access response message after transmitting a random access channel preamble selected from a plurality of random access channel preambles.

Paragraph 12. The method of paragraph 11, wherein the random access channel preamble is selected to indicate the terminal device will transmit a request to receive an indication of the second preconfigured uplink resource configuration in association with the third message of the random access procedure.

13. The method of any of paragraphs 8 to 12, wherein prior to transmitting a request to receive an indication of the second preconfigured uplink resource configuration the terminal device is configured to use multiple preconfigured uplink resource configurations, and the request to receive an indication of the second preconfigured uplink resource configuration comprises an indication it is the first preconfigured uplink resource configurations that is to be replaced by the second preconfigured uplink resource configuration.

Paragraph 14. The method of any of paragraphs 8 to 13, wherein the request to receive an indication of the second preconfigured uplink resource configuration is transmitted by the terminal device with predefined transmission characteristics.

Paragraph 15. The method of paragraph 8, wherein the request to receive an indication of the second preconfigured uplink resource configuration is transmitted by the terminal device in accordance with the first preconfigured uplink resource configuration.

Paragraph 16. The method of paragraph 8 or 15, wherein transmitting the request to receive an indication of the second preconfigured uplink resource configuration comprises transmitting predefined reference signalling.

Paragraph 17. The method of any of paragraphs 1 to 16, wherein the step of determining a second preconfigured uplink resource configuration comprises receiving an indication of the second preconfigured uplink resource configuration.

Paragraph 18. The method of paragraph 17, wherein the indication of the second preconfigured uplink resource configuration is received in association with downlink signalling in a random access procedure initiated by the terminal device.

Paragraph 19. The method of paragraph 18, wherein the downlink signalling message of the random access procedure in association with which the indication of the second preconfigured uplink resource configuration is received is a fourth message of the random access procedure.

Paragraph 20. The method of paragraph 17, wherein the indication of the second preconfigured uplink resource configuration is received in association with downlink control information signalling.

Paragraph 21. The method of paragraph 20, wherein the downlink control information signalling is associated with acknowledgement signalling received by the terminal device in respect of a previous transmission of data in accordance with the first preconfigured uplink resource configuration.

Paragraph 22. The method of paragraph 17, wherein the indication of the second preconfigured uplink resource configuration is received using radio resource control, RRC, connected mode signalling.

Paragraph 23. The method of any of paragraphs 1 to 22, wherein the second preconfigured uplink resource configuration is determined before the terminal device determines the first preconfigured uplink resource configuration should be changed.

Paragraph 24. The method of paragraph 23, wherein the second preconfigured uplink resource configuration is defined so that transmissions made in accordance with the second preconfigured uplink resource configuration have a greater chance of being successfully received than transmissions made in accordance with the first preconfigured uplink resource configuration for the same radio channel conditions.

Paragraph 25. The method of paragraph 24, further comprising the terminal device receiving an indication of a third preconfigured uplink resource configuration to use after transmitting data in accordance with the second preconfigured uplink resource configuration, and subsequently transmitting data in accordance with the third preconfigured uplink resource configuration.

Paragraph 26. The method of any of paragraphs 23 to 25, further comprising the terminal device seeking to receive an indication of a third preconfigured uplink resource configuration to use after transmitting data in accordance with the second preconfigured uplink resource configuration, and transmitting a request to receive the indication of the third preconfigured uplink resource configuration if the indication of a third preconfigured uplink resource configuration is not received with a predetermined period after starting to transmit data in accordance with the second preconfigured uplink resource configuration.

Paragraph 27. The method of any of paragraphs 23 to 26, wherein the first preconfigured uplink resource configuration is dedicated to the terminal device and the second preconfigured uplink resource configuration is common to a plurality of terminal devices.

Paragraph 28. The method of any of paragraphs 1 to 27, wherein radio resources associated with the first and second preconfigured uplink resource configurations comprise the same frequencies but different times.

Paragraph 29. The method of any of paragraphs 1 to 28, wherein the second preconfigured uplink resource configuration is associated with an increased number of transmission opportunities available for the terminal device to use for preconfigured uplink resource transmissions.

Paragraph 30. The method of any of paragraphs 1 to 29, wherein the first preconfigured uplink resource configuration comprises an indication of a configuration setting for one or more parameters selected from the group comprising: (i) an indication of a time after which the terminal device should determine a new timing advance; (ii) an indication of a power the terminal device should use for transmitting data in accordance with the first preconfigured uplink resource configuration; (iii) an indication of the degree of repetition the terminal device should use for transmitting data in accordance with the first preconfigured uplink resource configuration; (iv) an indication of a modulation coding scheme the terminal device should use for transmitting data in accordance with the first preconfigured uplink resource configuration; (v) an indication of times and/or frequencies for radio resources the terminal device should use for transmitting data in accordance with the first preconfigured uplink resource configuration; (vi) an indication of periodicity for the opportunities for transmitting data in accordance with the first preconfigured uplink resource configuration and/or a start time for the opportunities for transmitting data in accordance with the first preconfigured uplink resource configuration relative to a predefined reference time point; and (vii) an indication of a number of transmission opportunities available for the terminal device to use for transmissions in accordance with the first preconfigured uplink resource configuration.

Paragraph 31. The method of any of paragraphs 1 to 30, wherein the second preconfigured uplink resource configuration comprises an indication of a configuration setting for one or more parameters selected from the group comprising: (i) an indication of a time after which the terminal device should determine a new timing advance; (ii) an indication of a power the terminal device should use for transmitting data in accordance with the second preconfigured uplink resource configuration; (iii) an indication of the degree of repetition the terminal device should use for transmitting data in accordance with the second preconfigured uplink resource configuration; (iv) an indication of a modulation coding scheme the terminal device should use for transmitting data in accordance with the second preconfigured uplink resource configuration; (v) an indication of times and/or frequencies for radio resources the terminal device should use for transmitting data in accordance with the second preconfigured uplink resource configuration; (vi) an indication of periodicity for the opportunities for transmitting data in accordance with the first preconfigured uplink resource configuration and/or a start time for the opportunities for transmitting data in accordance with the first preconfigured uplink resource configuration relative to a predefined reference time point; and (vii) an indication of a number of transmission opportunities available for the terminal device to use for transmissions in accordance with the second preconfigured uplink resource configuration.

Paragraph 32. A terminal device for use in a wireless telecommunication system, wherein the terminal device comprises controller circuitry and transceiver circuitry configured to operate together such that the terminal device is operable to: determine a first preconfigured uplink resource configuration to use for a plurality of preconfigured uplink resource transmissions;

transmit data in accordance with the first preconfigured uplink resource configuration; determine the first preconfigured uplink resource configuration should be changed; determine a second preconfigured uplink resource configuration to use for a plurality of preconfigured uplink resource transmissions; and transmit data in accordance with the second preconfigured uplink resource configuration.

Paragraph 33. Circuitry for a terminal device for use in a wireless telecommunication system, wherein the circuitry comprises controller circuitry and transceiver circuitry configured to operate together such that the circuitry is operable to cause the terminal device to: determine a first preconfigured uplink resource configuration to use for a plurality of preconfigured uplink resource transmissions; transmit data in accordance with the first preconfigured uplink resource configuration; determine the first preconfigured uplink resource configuration should be changed; determine a second preconfigured uplink resource configuration to use for a plurality of preconfigured uplink resource transmissions; and transmit data in accordance with the second preconfigured uplink resource configuration.

Paragraph 34. A method of operating a network access node in a wireless telecommunication system, the method comprising; determining a first preconfigured uplink resource configuration to use for receiving a plurality of preconfigured uplink resource transmissions from a terminal device; receiving data transmitted by the terminal device in accordance with the first preconfigured uplink resource configuration; determining the first preconfigured uplink resource configuration should be changed; determining a second preconfigured uplink resource configuration to use for receiving a plurality of preconfigured uplink resource transmissions from a terminal device; and receiving data transmitted by the terminal device in accordance with the second preconfigured uplink resource configuration.

Paragraph 35. A network access node for use in a wireless telecommunication system, wherein the network access node comprises controller circuitry and transceiver circuitry configured to operate together such that the network access node is operable to; determine a first preconfigured uplink resource configuration to use for receiving a plurality of preconfigured uplink resource transmissions from a terminal device; receive data transmitted by the terminal device in accordance with the first preconfigured uplink resource configuration; determine the first preconfigured uplink resource configuration should be changed; determine a second preconfigured uplink resource configuration to use for receiving a plurality of preconfigured uplink resource transmissions from a terminal device; and receive data transmitted by the terminal device in accordance with the second preconfigured uplink resource configuration.

Paragraph 36. Circuitry for a network access node for use in a wireless telecommunication system, wherein the circuitry comprises controller circuitry and transceiver circuitry configured to operate together such that the circuitry is operable to cause the network access node to: determine a first preconfigured uplink resource configuration to use for receiving a plurality of preconfigured uplink resource transmissions from a terminal device; receive data transmitted by the terminal device in accordance with the first preconfigured uplink resource configuration; determine the first preconfigured uplink resource configuration should be changed; determine a second preconfigured uplink resource configuration to use for receiving a plurality of preconfigured uplink resource transmissions from a terminal device; and receive data transmitted by the terminal device in accordance with the second preconfigured uplink resource configuration.

Further particular and preferred aspects of the present invention are set out in the accompanying independent and dependent claims. It will be appreciated that features of the dependent claims may be combined with features of the independent claims in combinations other than those explicitly set out in the claims.

### REFERENCES

[1] RP-161464, “Revised WID for Further Enhanced MTC for LTE,” Ericsson, 3GPP TSG RAN Meeting #73, New Orleans, USA, September 19-22, 2016
[2] RP-161901, “Revised work item proposal: Enhancements of NB-IoT”, Huawei, HiSilicon, 3GPP TSG RAN Meeting #73, New Orleans, USA, September 19-22, 2016
[3] RP-170732, “New WID on Even further enhanced MTC for LTE,” Ericsson, Qualcomm, 3GPP TSG RAN Meeting #75, Dubrovnik, Croatia, March 6-9, 2017
[4] RP-170852, “New WID on Further NB-IoT enhancements,” Huawei, HiSilicon, Neul, 3GPP TSG RAN Meeting #75, Dubrovnik, Croatia, March 6-9, 2017
[5] RP-181878, “Revised WID: Additional MTC enhancements for LTE,” Ericsson, 3GPP TSG RAN Meeting #81, Gold Coast, Australia, Sep. 10-13, 2018
[6] RP-181451, “New WID on Rel-16 enhancements for NB-IoT,” Ericsson, Huawei, 3GPP TSG RAN Meeting #80, La Jolla, USA, June 11-14, 2018
[7] R1-1812101 “Final Report of 3GPP TSG RAN WG1 #94bis v1.0.0 (Chengdu, China, 8th 12h October 2018)”, 3GPP TSG RAN WG1 Meeting #95, Spokane, USA, November 12-16 2018
[8] Holma H. and Toskala A, “LTE for UMTS OFDMA and SC-FDMA based radio access”, John Wiley and Sons, 2009

1. A method of operating a terminal device in a wireless telecommunication system, the method comprising:
determining a first preconfigured uplink resource configuration to use for a plurality of preconfigured uplink resource transmissions;
transmitting data in accordance with the first preconfigured uplink resource configuration;
determining the first preconfigured uplink resource configuration should be changed;
determining a second preconfigured uplink resource configuration to use for a plurality of preconfigured uplink resource transmissions; and
transmitting data in accordance with the second preconfigured uplink resource configuration.

2. The method of claim 1, wherein the method further comprises the terminal device making measurements of radio channel conditions and determining the first preconfigured uplink resource configuration should be changed based on the measurements of radio channel conditions.

3. The method of claim 2, wherein the measurements of radio channel comprise measurements of a signal strength for signalling received by the terminal device.

4. The method of claim 1, wherein the step of determining the first preconfigured uplink resource configuration should be changed is based on the terminal device determining an application supported by the terminal device requires a change in how it reports data using the wireless telecommunication system.

5. The method of claim 1, wherein the step of determining the first preconfigured uplink resource configuration should be changed is based on the terminal device determining there are less than a predetermined amount of remaining opportunities for transmitting data in accordance with the first preconfigured uplink resource configuration.

6. The method of claim 1, wherein the step of determining the first preconfigured uplink resource configuration should be changed comprises the terminal device receiving signalling from another entity in the wireless telecommunication system which indicates the first preconfigured uplink resource configuration should be changed.

7. The method of claim 1, wherein the method further comprises the terminal device seeking to receive acknowledgement signalling in response to previous transmissions of data made in accordance with the first preconfigured uplink resource configuration, and determining the first preconfigured uplink resource configuration should be changed in response to failing to receive acknowledgement signalling in response to a predetermined number of previous transmissions of data made in accordance with the first preconfigured uplink resource configuration.

8. The method of claim 1, wherein the method further comprises the terminal device transmitting a request to receive an indication of the second preconfigured uplink resource configuration in response to determining the first preconfigured uplink resource configuration should be changed.

9. The method of claim 8, wherein transmitting the request to receive an indication of the second preconfigured uplink resource configuration comprises initiating a random access procedure and transmitting the request to receive an indication of the second preconfigured uplink resource configuration in association with an uplink signalling message of the random access procedure.

10. The method of claim 9, wherein the uplink signalling message of the random access procedure in association with which the request to receive an indication of the second preconfigured uplink resource configuration is transmitted is a first message of the random access procedure and comprises a random access channel preamble selected from a plurality of random access channel preambles to indicate the request to receive an indication of the second preconfigured uplink resource configuration.

11. The method of claim 9, wherein the uplink signalling message of the random access procedure in association with which the request to receive an indication of the second preconfigured uplink resource configuration is transmitted is a third message of the random access procedure, wherein the third message of the random access procedure is sent in response to receiving a random access response message after transmitting a random access channel preamble selected from a plurality of random access channel preambles.

12. The method of claim 11, wherein the random access channel preamble is selected to indicate the terminal device will transmit a request to receive an indication of the second preconfigured uplink resource configuration in association with the third message of the random access procedure.

13. The method of claim 8, wherein prior to transmitting a request to receive an indication of the second preconfigured uplink resource configuration the terminal device is configured to use multiple preconfigured uplink resource configurations, and the request to receive an indication of the second preconfigured uplink resource configuration comprises an indication it is the first preconfigured uplink resource configurations that is to be replaced by the second preconfigured uplink resource configuration.

14. The method of claim 8, wherein the request to receive an indication of the second preconfigured uplink resource configuration is transmitted by the terminal device with predefined transmission characteristics.

15. The method of claim 8, wherein the request to receive an indication of the second preconfigured uplink resource configuration is transmitted by the terminal device in accordance with the first preconfigured uplink resource configuration.

16. The method of claim 8, wherein transmitting the request to receive an indication of the second preconfigured uplink resource configuration comprises transmitting predefined reference signalling.

17. The method of claim 1, wherein the step of determining a second preconfigured uplink resource configuration comprises receiving an indication of the second preconfigured uplink resource configuration.

18.-22. (canceled)

23. The method of claim 1, wherein the second preconfigured uplink resource configuration is determined before the terminal device determines the first preconfigured uplink resource configuration should be changed.

24.-33. (canceled)

34. A method of operating a network access node in a wireless telecommunication system, the method comprising;
determining a first preconfigured uplink resource configuration to use for receiving a plurality of preconfigured uplink resource transmissions from a terminal device;
receiving data transmitted by the terminal device in accordance with the first preconfigured uplink resource configuration;
determining the first preconfigured uplink resource configuration should be changed;
determining a second preconfigured uplink resource configuration to use for receiving a plurality of preconfigured uplink resource transmissions from a terminal device; and
receiving data transmitted by the terminal device in accordance with the second preconfigured uplink resource configuration.

35. A network access node for use in a wireless telecommunication system, wherein the network access node comprises controller circuitry and transceiver circuitry configured to operate together such that the network access node is operable to;
determine a first preconfigured uplink resource configuration to use for receiving a plurality of preconfigured uplink resource transmissions from a terminal device;
receive data transmitted by the terminal device in accordance with the first preconfigured uplink resource configuration;
determine the first preconfigured uplink resource configuration should be changed;
determine a second preconfigured uplink resource configuration to use for receiving a plurality of preconfigured uplink resource transmissions from a terminal device; and
receive data transmitted by the terminal device in accordance with the second preconfigured uplink resource configuration.

36. (canceled)
